(19) United States
(12) Patent Application Publication
(10) Pub. No.: US 2013/0021201 A1
(43) Pub. Date: Jan. 24, 2013

(54) Assisted Global Navigation Satellite System (AGNSS) with Precise Ionosphere Model Assistance

(71) Applicants: Manuel del CASTILLO, Madrid (ES); David Albert Lundgren, Mill Valley, CA (US); James LaMance, Hixson, TN (US)

(72) Inventors: Manuel del CASTILLO, Madrid (ES); David Albert Lundgren, Mill Valley, CA (US); James LaMance, Hixson, TN (US)

(73) Assignee: Broadcom Corporation, Irvine, CA (US)

(21) Appl. No.: 13/246,480

(22) Filed: Sep. 27, 2011

Related U.S. Application Data
(60) Provisional application No. 61/509,229, filed on Jul. 19, 2011.

(51) Int. Cl. G01S 19/21; G01S 19/25

(52) U.S. Cl. 342/357.59; 342/357.64

(57) ABSTRACT

Embodiments enable higher accuracy GNSS performance by generating local/regional ionosphere models tailored to specific local/regional areas of interest and by using location-based delivery of the local/regional ionosphere models to mobile GPS receivers. Different types and levels of reference locations (e.g., Cell ID (CID), Location Area Code (LAC), Radio Network Controller ID (RNC-ID), Mobile Country Code (MCC)) can be used to estimate the location of mobile GPS receivers and to deliver the appropriate local/regional ionosphere models to the mobile GPS receivers. According to embodiments, the local/regional ionosphere models are fit into the same 8-parameter set as the broadcast global ionosphere model, therefore being compatible with existing GPS receivers that accept the broadcast global ionosphere model.

### CROSS-REFERENCE TO RELATED APPLICATION(S)

The present application claims the benefit of U.S. Provisional Application No. 61/509,229, filed Jul. 19, 2011, entitled “Precise AGNSS IONO Assistance (PIONO) Coupled with Different Levels of Reference Location,” which is incorporated herein by reference in its entirety.

### BACKGROUND

1. Field of the Invention

The present invention relates generally to the Global Positioning System (GPS).

2. Background Art

The ionosphere is the uppermost layer of the atmosphere and is made of a plasma of ions. The ionosphere filters some of the Sun's most harmful frequencies, such as, extreme ultraviolet rays and X-rays.

The character of the ionosphere varies greatly in space and time and is driven strongly by overall solar activity. For example, the character of the ionosphere depends on sunspot cycles, seasonal and diurnal cycles, and solar geomagnetic storms.

Ionospheric variations greatly affect GNSS (Global Navigation Satellite System) signals. Specifically, the ionosphere affects GNSS signal propagation velocity, causing variable time delays (ionospheric delays). As such, GNSS positioning can be impacted fundamentally by ionospheric variations.

The GPS (Global Positioning System) broadcast ephemeris message contains a model for the ionosphere consisting of 8 terms. Although the 8-element ionosphere model provided by the broadcast ephemeris is very good for a global model containing relatively few parameters, the global model can lead to a mis-modeling of 50 meters or more of ionosphere range delay during times of high solar activity.

Accordingly, there is a need for more accurate modeling of the ionosphere for better GNSS positioning, especially during periods of high solar activity.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 illustrates solar activity over time.

FIG. 2 is an example system capable of performing embodiments of the present invention.

FIG. 3 is a process flowchart of a method of generating local/regional predictive ionosphere models according to an embodiment of the present invention.

FIG. 4 is a process flowchart of a method of providing a local/regional predictive ionosphere model to a mobile GPS receiver according to an embodiment of the present invention.

FIG. 5 illustrates example ionospheric delay data as provided by the Crustal Dynamics Data Information System (CDDIS).

FIG. 6 illustrates an example technique for generating predictions of ionospheric delays according to an embodiment of the present invention.

FIG. 7 is a plot that illustrates example improvement gain in position determination according to embodiments of the present invention.

The present invention will be described with reference to the accompanying drawings. Generally, the drawing in which an element first appears is typically indicated by the leftmost digit(s) in the corresponding reference number.

### DETAILED DESCRIPTION OF EMBODIMENTS

The ionosphere is the uppermost layer of the atmosphere and is made of a plasma of ions. The character of the ionosphere varies greatly in space and time and is driven strongly by overall solar activity. Ionospheric variations greatly affect GNSS (Global Navigation Satellite System) signals. In particular, the ionosphere affects GNSS signal propagation velocity, causing variable time delays (ionospheric delays).

Ionospheric delays are potentially the largest error source for many GPS (Global Positioning System) applications (multipath propagation has the potential to cause errors on the order of hundreds of meters and is the largest for urban applications). For example, unaccounted for ionospheric delays can cause pseudorange errors in excess of 100 meters on low elevations satellite during periods of high solar activity and on the order of 10 meters during periods of low solar activity.

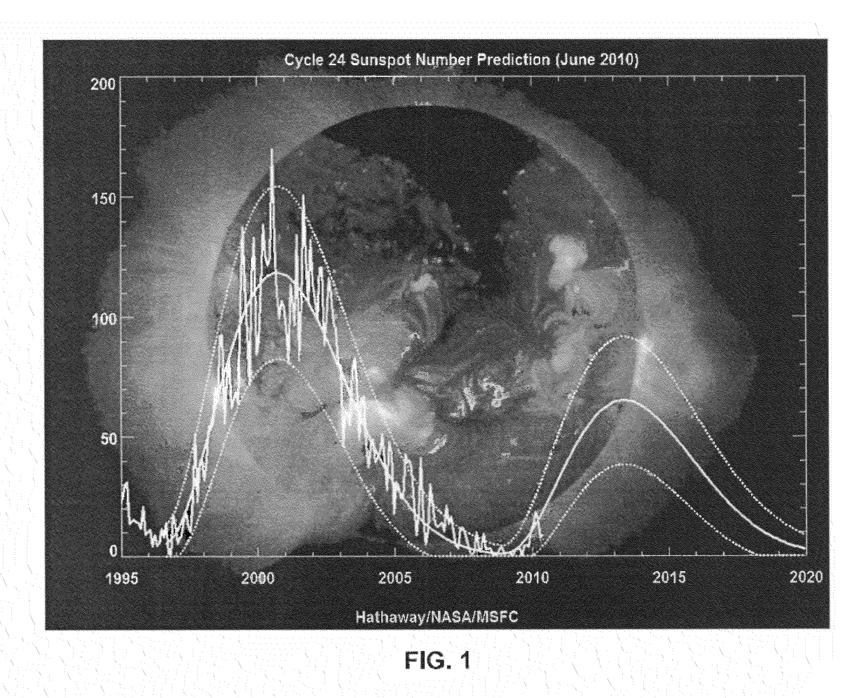

FIG. 1 illustrates solar activity versus time. Specifically, FIG. 1 is a plot of the sunspot number for the previous 11-year solar cycle (1997 to 2008) and for the current solar cycle (Cycle 24, which began in January 2008). The sunspot number represents a count of the number of sunspots present on the surface of the Sun, and is one measure of solar activity.

As shown in FIG. 1, the current solar cycle is not predicted to be as large as the previous cycle. For example, the previous solar cycle had a maximum in the years 2000-2001 with the sunspot number exceeding 150. The current solar cycle is anticipated to have a maximum around the years 2013-2014, but is not expected to reach such large sunspot number values. Nonetheless, over the next few years, it is predicted that solar activity will ramp up and that ionosphere induced pseudorange errors will also increase to become a major error source for GPS applications.

Conventional GPS receivers partially correct for ionosphere induced pseudorange errors using standard global ionosphere models, broadcast by GNSS satellites. The standard broadcast ionosphere models are contained in the GPS broadcast ephemeris message, and are a global thin shell approximation of a TEC (Total Electron Content) map. The models generate ionospheric delay as a function of time-of-day and latitude, using 8 Klobuchar parameters (alpha0 . . . alpha3, beta0 . . . beta3) that fit the amplitude and period of a cosine function to observed data.

Although the 8-parameter ionosphere model provided by the broadcast ephemeris is very good for a global model containing relatively few parameters, the model can lead to a mis-modeling of 50 meters or more of ionosphere range delay during times of high solar activity. In addition, the model has significant variability that tends to be latitude dependent. For example, while the Northern hemisphere mid-latitudes tend to be well-modeled, the tropics (where the ionospheric variability and magnitude are the highest) and the Southern hemisphere are less accommodated by the broadcast model.

Accordingly, there is a need for more accurate modeling of the ionosphere for better GNSS positioning and to sustain GNSS mobile device accuracy during periods of high solar activity.

Embodiments of the present invention enable higher accuracy GNSS performance by generating local/regional predictive ionosphere models tailored to specific local/regional areas of interest and by using location-based delivery of the local/regional predictive ionosphere models to mobile GPS receivers. According to embodiments, the local/regional predictive ionosphere models are fit into the same 8-parameter set as the broadcast global ionosphere model, therefore being compatible (without requiring any hardware/software modification to existing GPS receivers) with existing GPS receivers that accept the broadcast global ionosphere model.

Different types and levels of reference locations (e.g., Cell ID (CID), Location Area Code (LAC), Radio Network Controller ID (RNC-ID), Mobile Country Code (MCC)) can be used to estimate the location of mobile GPS receivers and to deliver the appropriate local/regional predictive ionosphere models to the mobile GPS receivers. For example, in an embodiment, if the CID of the network cell in which the mobile GPS receiver is located is known, then a local predictive ionosphere model generated based on the CID (as reference location) is delivered to the mobile GPS receiver. However, if the CID (or other similar level location estimate, such as, LAC or RNC-ID) is not known, then a regional ionosphere model generated based, for example, on the Mobile Country Code (MCC) associated with the mobile GPS receiver is delivered to the mobile GPS receiver. In embodiments, local/regional predictive models are delivered to GPS receivers as part of the Assistance Data of an Assisted GPS (AGPS) system.

According to embodiments, local/regional predictive ionosphere models can be generated to model up to 10 days in the future, matching existing LTO (Long Term Orbits) validity. Local predictive models are valid for ˜250 km around forecast center, a range matching CID, LAC, or RNC-ID reference location uncertainty. Regional predictive models are valid for ˜3000 km around forecast center, a range matching MCC reference location uncertainty. Local/regional predictive ionosphere models reduce the 50 meters of error (attributed to the broadcast global model) down to just a few meters.

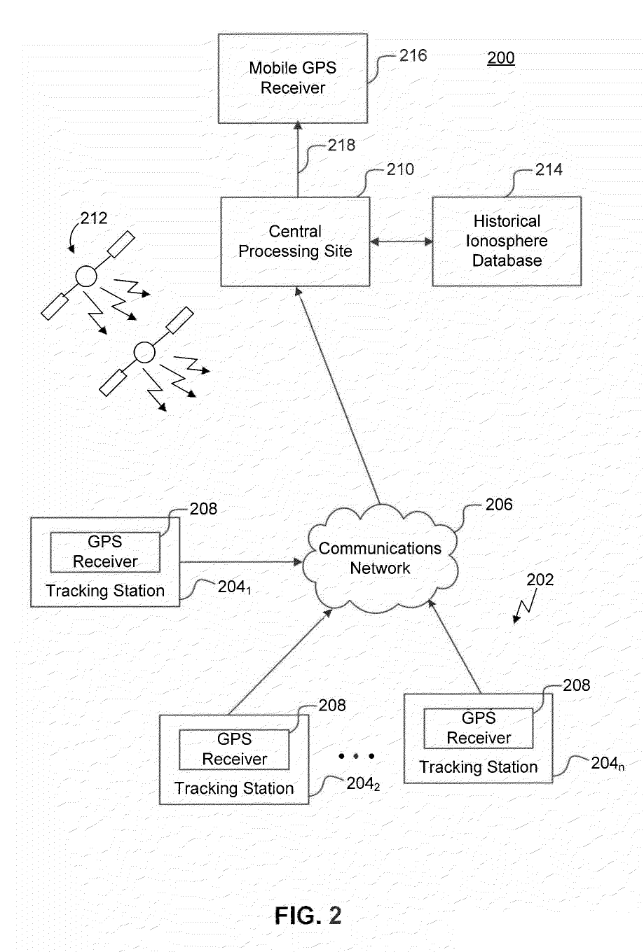

FIG. 2 is an example AGPS system 200 capable of performing embodiments of the present invention. As shown in FIG. 2, example AGPS system 200 includes a reference station network 202, a central processing site 210, a plurality of GNSS satellites 212, a historical ionosphere data database 214, and a mobile GPS receiver 216.

Reference station network 202 includes a plurality of tracking stations 204, coupled to one another through a communications network 206. Tracking stations 204 are deployed over a wide area and each includes a GPS receiver 208. Tracking stations 204 collect ephemeris data from satellites 212. In an embodiment, tracking stations 204 each further calculates historical localized ionospheric delays based on its location. Tracking stations 204 are fixed and have knowledge of their exact locations. Therefore, positioning errors attributable to ionospheric delays as well as ionospheric delays themselves can be derived using dual frequency GPS receivers or similar radio based techniques. Tracking stations 204 may be part of a proprietary reference network. Additionally or alternatively, tracking stations 204 may include WAAS (Wide Area Augmentation System)-enabled GPS receivers capable of receiving real-time ionospheric delays broadcast by a geostationary satellite (e.g., on the GPS L1 frequency).

Reference station network 202 provides the collected ephemeris data, the calculated localized ionospheric delays, and/or the received real-time ionospheric delays to central processing site 210 via communications network 206.

Central processing site 210 provides Assistance Data, including the latest ephemeris data, to mobile GPS receiver 216 via a communications link 218. Communications link 218 may include one or more of wired and wireless links. Additionally, in an embodiment, if central processing site 210 knows the location of mobile GPS receiver 216, central processing site 210 may include in the Assistance Data a local/regional predictive ionosphere model tailored based on the location of mobile GPS receiver 216. In embodiments, the delivered local/regional predictive ionosphere model is generated based on one or more of the localized ionosphere delays generated and provided by reference station network 202, broadcast ionospheric delays received and provided by reference station network 202, and historical ionosphere data that can be obtained from a database 214 (e.g., the Crustal Dynamics Data Information System (CDDIS) database).

Mobile GPS receiver 216 uses the Assistance Data provided by central processing site 210 to enhance its position determination. In particular, mobile GPS receiver 216 uses the ephemeris data contained in the Assistance Data in detecting GPS signals from satellites 212. Additionally, mobile GPS receiver 216 uses the local/regional predictive ionosphere model contained in the Assistance Data to account for ionospheric delays incurred by the GPS signals. In an embodiment, mobile GPS receiver 216 processes the local/regional predictive ionosphere model in the same manner as it processes a global ionosphere model broadcast by GNSS satellites.

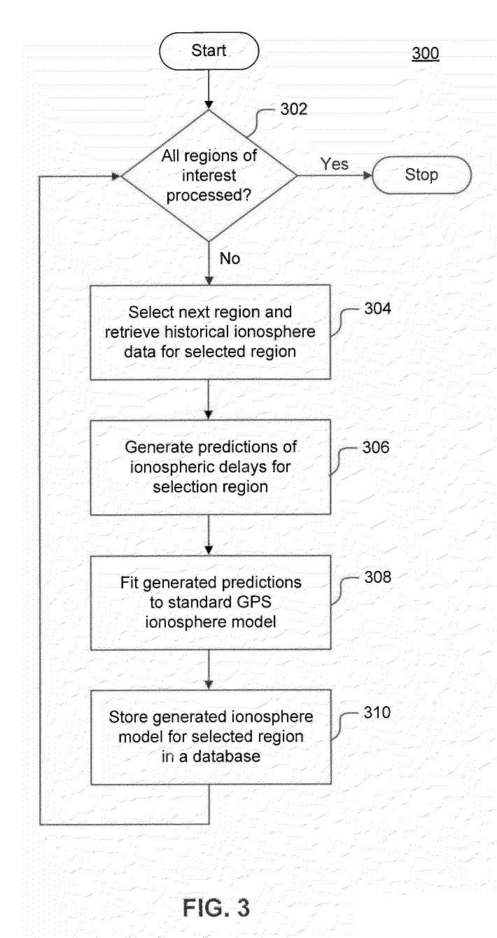

FIG. 3 is a process flowchart 300 of a method of generating local/regional predictive ionosphere models according to an embodiment of the present invention. Process 300 may be performed by central processing site 210 of AGPS system 200, for example. Process 300 may be performed once per day, but may be performed more than once per day if higher ionosphere modeling accuracy is desired.

As shown in FIG. 3, process 300 begins in step 302, which includes determining whether or not all regions of interest have been processed. The regions of interest represent geographical regions (of similar or different sizes) for which local/regional predictive ionosphere models are being computed. Typically, the regions of interest are each defined by a latitude range and a longitude range. If all regions of interest have been processed, process 300 terminates. Otherwise, process 300 proceeds to step 304.

Step 304 includes selecting the next region of interest (from a list, for example) and retrieving historical ionosphere data for the selected region. In an embodiment, the historical ionosphere data includes ionospheric delays for the selected region, and are retrieved from one or more local or remote databases. For example, the historical ionosphere data may include localized ionospheric delays generated by a reference network (such as reference station network 202) and stored in a local database, broadcast ionospheric delays received from an external system (e.g., ionospheric delays broadcast by a WAAS) and stored in a local database, and/or historical ionospheric delays obtained from an external database (e.g., ionospheric delays obtained from the CDDIS database).

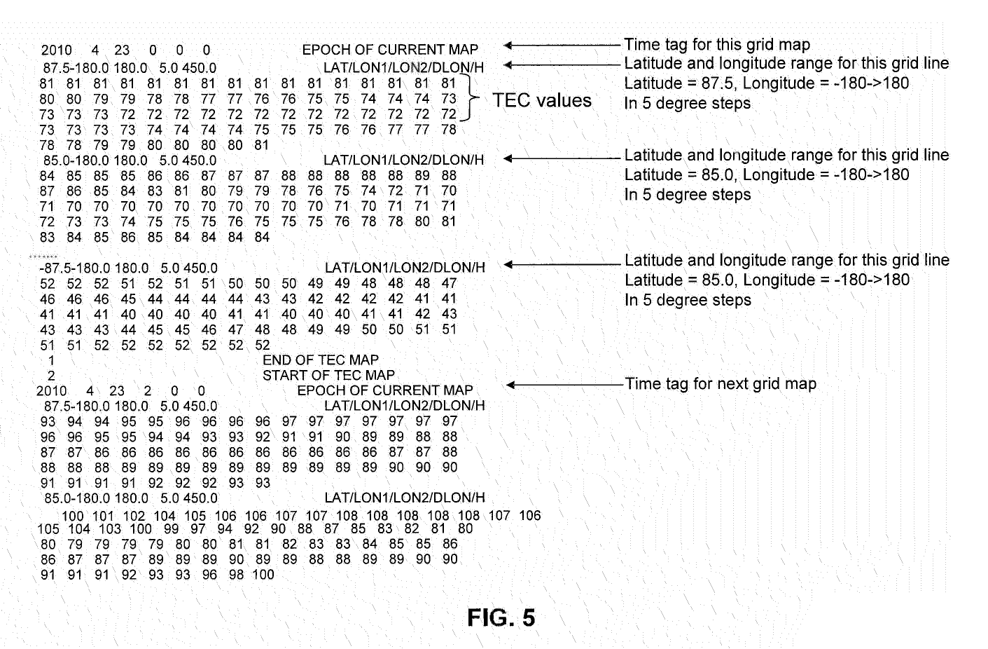

Historical ionosphere data retrieved from different data sources may have different formats and/or granularity. For illustration, FIG. 5 shows example ionospheric delay data as provided by the Crustal Dynamics Data Information System (CDDIS). As shown in FIG. 5, the ionospheric delay data is provided in the form of successive grid maps each with a respective time tag that indicates the validity time-of-day of the grid map (in FIG. 5, each grid map includes delays that correspond to and are valid for a 2-hour interval of the day). Typically, 12 grid maps are provided per day. Each grid map includes a plurality of grid lines, with each grid line corresponding to a respective latitude and longitude range (sub-region of the selected region). In the example data of FIG. 5, each grid line covers a range consisting of a fixed latitude and a longitude from −180 degrees to +180 degrees, in 5 degrees steps (e.g., the first grid line in the first grid map covers a range having a latitude of 87.5 degrees and a longitude from −180 degrees to +180 degrees). Grid lines are provided in 2.5 degrees latitude increments, covering 70 unique latitude (from −87.5 to 87.5 degrees). As such, each grid map includes 5040 grid points or delay values. Ionospheric delays for each latitude-longitude combination are provided in the form of TEC units. TEC units can be converted to meters of delay at the GPS L1 frequency according to a well-known formula.

In an embodiment, historical ionosphere data retrieved in step 304 includes ionospheric delays for the selected region over a 5-day period. In other words, for each latitude/longitude combination from the selected region (for which delay values are available in local/remote databases), 5 historical delay values, one for each day, are retrieved.

Referring back to FIG. 3, step 306 includes generating predictions of ionospheric delays for the selected region. In an embodiment, the predictions of ionospheric delays are generated based on the historical ionosphere data for the selected region retrieved in step 304. Historical ionosphere data retrieved from one or more local/remote database can be used, alone or in combination, to generate the predictions. In an embodiment, the historical ionosphere data is augmented (e.g., by interpolation, extrapolation, or other similar known methods) to increase its granularity, prior to being used to generate the predictions.

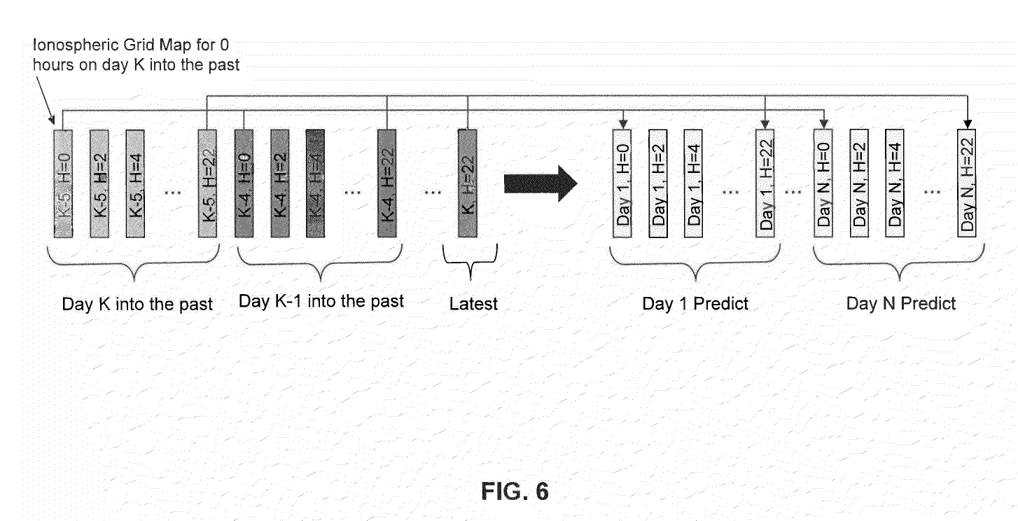

In an embodiment, the predictions are generated based on the assumption that the ionospheric delays for the next N days (where N is a desired period of validity of the predictions) are a function of the ionospheric delays for the previous K days. This assumption is based on the fact that the ionosphere has a daily pattern (the ionosphere rotates with the Earth and thus has a once a day peak around noon) that does not change significantly from day to day. FIG. 6 illustrates a method for generating predictions of ionospheric delays based on this assumption. As shown in FIG. 6, the method generates an ionospheric grid map prediction to be used for the future N days (for each time period of the day) based on corresponding grid maps of the previous K days (for the same time period of the day). In an embodiment, K is equal to 5 and N is equal to 10, i.e., the ionospheric grid map prediction is based on 5 days of historical data and can be used for 10 days into the future.

In an embodiment, the ionospheric grid map prediction is generated as the mean of the corresponding grid maps of the previous K days. Other mathematical methods may also be used to generate the ionospheric grid map prediction based on the corresponding grid maps of the previous K days, including, for example, linear modeling, harmonic modeling, Taylor series, polynomial curve fitting, extrapolation, or similar known techniques.

Referring back to FIG. 3, step 308 includes fitting the generated predictions to a standard GPS ionosphere model. As described above, the standard GPS ionosphere model (which is contained in the GPS broadcast ephemeris message) models ionospheric delay as a function of time-of-day and 8 Klobuchar parameters. In an embodiment, step 308 includes fitting the 8 model parameters to the predictions using a mathematical technique, such as least mean squares error (LMSE), Kalman filtering, linear search, or non-linear search algorithms (e.g., simplex or Nedler-Mead). Since the number of parameters being fit to the predictions (a maximum of 8) and the number of predictions (hourly ionospheric delays) are small, the computational processing required in step 308 is minimal.

Subsequently, in step 310, process 300 includes storing the generated standard GPS ionosphere model for the selected region in a database. In an embodiment, generated ionosphere models are stored in an AGPS database and then provided on-demand to mobile GPS receivers. The generated ionosphere models may be delivered separately or as part of AGPS Assistance Data provided to the mobile GPS receivers. After step 310, process 300 returns to step 302, described above, and either terminates or selects another region of interest to process.

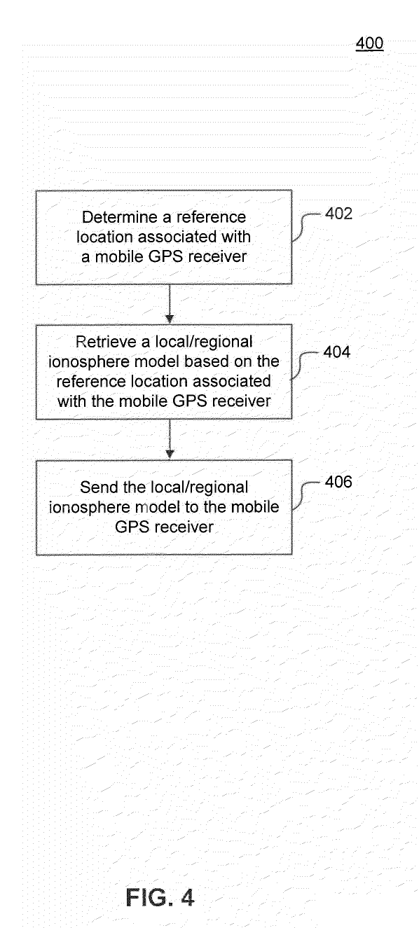

FIG. 4 is a process flowchart 400 of a method of providing a local/regional predictive ionosphere model to a GPS receiver according to an embodiment of the present invention.

As shown in FIG. 4, process 400 begins in step 402, which includes determining a reference location associated with a mobile GPS receiver. The reference location associated with the mobile GPS receiver estimates the location of the mobile GPS receiver. According to embodiments, different types and levels of reference locations (e.g., Cell ID (CID), Location Area Code (LAC), Radio Network Controller ID (RNC-ID), Mobile Country Code (MCC)) can be used to estimate the location of the mobile GPS receiver.

Subsequently, in step 404, process 400 includes retrieving a local/regional ionosphere model based on the reference location associated with the mobile GPS receiver. In an embodiment, the ionosphere model retrieved in step 404 is calculated a priori and stored in a local database. For example, the ionosphere model is calculated using process 300 described above in FIG. 3. Alternatively, the ionosphere model is calculated on-demand.

According to embodiments, the accuracy of the ionosphere model retrieved in step 404 depends on the location uncertainty of the mobile GPS receiver. In other words, the lower the location uncertainty of the mobile GPS receiver is, the more precise the ionosphere model can be. For example, in an embodiment, if the mobile GPS receiver's location can be estimated using a wireless network CID (i.e., the wireless network cell in which the mobile GPS receiver is located is known), then a local predictive ionosphere model generated based on the CID (as reference location) is delivered to the mobile GPS receiver. However, if the CID (or other similar level location estimate, such as, LAC or RNC-ID) is not known, then a regional ionosphere model generated based, for example, on the Mobile Country Code (MCC) associated with the mobile GPS receiver is delivered to the mobile GPS receiver. The local predictive ionosphere model generated based on the CID provides a more precise ionosphere model to the mobile GPS receiver than a regional ionosphere model generated based on the MCC, because it models the ionosphere over a smaller geographical area with the same number of parameters.

Process 400 terminates with step 406, which includes sending the local/regional predictive ionosphere model to the mobile GPS receiver. In embodiments, the local/regional predictive model is delivered to the mobile GPS receiver as part of the Assistance Data of an Assisted GPS (AGPS) system. Accordingly, the local/regional predictive ionosphere model is sent to the mobile GPS receiver via a wireless cellular network. The local/regional predictive ionosphere model can be sent to the mobile GPS receiver according to a periodic schedule or on-demand after a request from the mobile GPS receiver.

The mobile GPS receiver uses the local/regional predictive ionosphere model to calculate an ionospheric delay value based on its location and the time of day. The mobile GPS receiver uses the calculated value in its position computation algorithm, in order to account for pseudorange errors caused by the ionosphere.

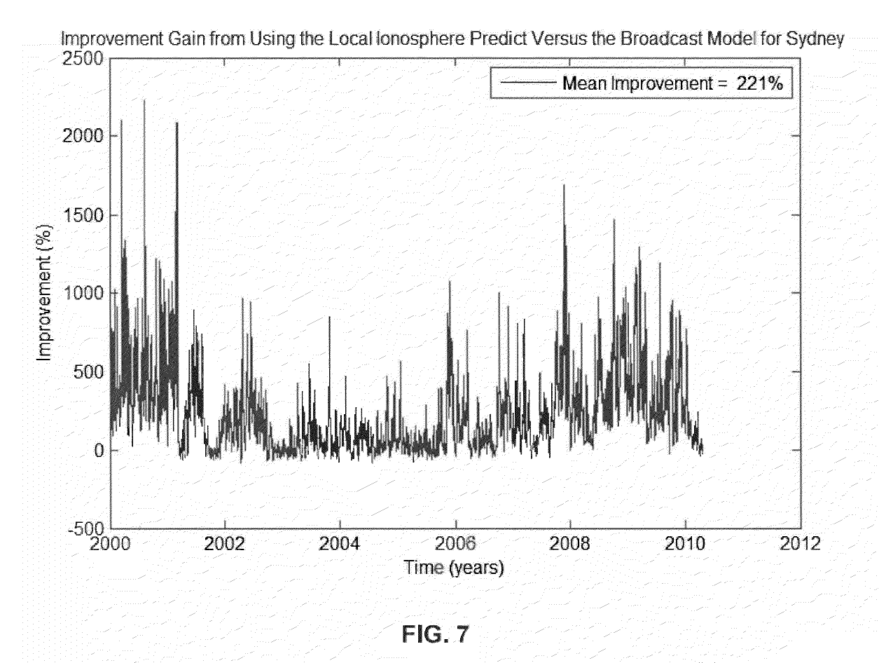

FIG. 7 is a plot that illustrates example improvement gain in position determination from using a local predictive ionosphere model according to embodiments of the present invention versus the broadcast ionosphere model. The results in FIG. 7 are based on using a 10-day prediction period (i.e., predictions are calculated for the next 10 days from past historical data). To get an estimate of performance improvement, the predictive ionosphere model was computed for the past 10 years, covering the time from the last solar maximum, and compared with the performance of the broadcast ionosphere model (both models were tested against the post-priori ionosphere model from the National Aeronautics and Space Administration (NASA)). On average, as shown in FIG. 7, the performance improvement is between a factor of 2-4. During higher solar activity times, the advantage of the local predictive model grows. The local predictive model also better compensates for seasonal variability even during periods of low ionospheric activity.

Embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of embodiments of the present invention should not be limited by any of the above-described exemplary embodiments, but should be defined only in accordance with the following claims and their equivalents.

What is claimed is:

1. A method of providing precise ionosphere model assistance to a mobile Global Positioning System (GPS) receiver, comprising:
selecting a region of interest;
retrieving historical ionosphere data for the selected region of interest;
generating predictions of ionospheric delays for the selected region based on the historical ionosphere data;
fitting the predictions of ionospheric delays to a standard GPS ionosphere model to generate a predictive ionosphere model for the selected region; and
storing the predictive ionosphere model in a database.

2. The method of claim 1, wherein the region of interest represents a geographical area represented by a latitude range and a longitude range.

3. The method of claim 1, wherein the historical ionosphere data includes localized ionospheric delays generated by a reference network.

4. The method of claim 1, wherein the historical ionosphere data includes broadcast ionospheric delays sent by a Wide Area Augmentation System (WAAS).

5. The method of claim 1, wherein the historical ionosphere data includes historical ionospheric delays stored in a database.

6. The method of claim 5, wherein the database includes a Crustal Dynamics Data Information System (CDDIS) database.

7. The method of claim 1, wherein the historical ionosphere data includes ionospheric delays for the selected region of interest over a K-day period, wherein K is any integer number.

8. The method of claim 1, wherein the historical ionosphere data includes a plurality of grid maps, each grid map having a respective time tag that indicates a validity time-of-day for the grid map.

9. The method of claim 8, wherein each grid map includes a plurality of grid lines, each grid line including ionospheric delays for a respective sub-region within the selected region of interest.

10. The method of claim 1, further comprising:
augmenting the historical ionosphere data prior to said generating step.

11. The method of claim 1, wherein said generating step comprises:
generating predicted ionospheric delays for a future N-day period based on historical ionospheric delays for a past K-day period, where N and K are integer numbers.

12. The method of claim 11, wherein the predicted ionospheric delays for the future N-day period are generated by averaging the historical ionospheric delays for the past K-day period.

13. The method of claim 11, wherein N is equal to 10 and K is equal to 5.

14. The method of claim 1, wherein said fitting step comprises:
applying one or more of a least mean squares error (LMSE), Kalman filtering, linear search, and non-linear search algorithm to the predictions of ionospheric delays to generate a plurality of model parameters of the standard GPS ionosphere model.

15. The method of claim 14, wherein the plurality of model parameters include 8 Klobuchar parameters.

16. The method of claim 1, wherein the method is performed by an Assisted GPS (AGPS) processing site.

17. The method of claim 1, further comprising:
retrieving the predictive ionosphere model from the database; and
sending the predictive ionosphere model to a mobile GPS receiver determined to be within the selected region.

18. The method of claim 17, wherein the predictive ionosphere model is sent to the mobile GPS receiver using Assisted GPS (AGPS).

19. The method of claim 17, further comprising:
determining a reference location associated with the mobile GPS receiver, wherein the reference location estimates a current position of the mobile GPS receiver.

20. The method of claim 19, wherein the reference location associated with the mobile GPS receiver includes one of a wireless network cell ID (CID), a Location Area Code (LAC), a Radio Network Controller ID (RNC-ID), and a Mobile Country Code (MCC).

21. The method of claim 1, wherein the region of interest is defined by a wireless network cell ID (CID) associated with a mobile GPS receiver.
